(19) United States
(12) Patent Application Publication
(10) Pub. No.: US 2017/0160099 A1
(43) Pub. Date: Jun. 8, 2017

(54) FACILITY-INFORMATION DISPLAY CONTROL DEVICE, FACILITY-INFORMATION DISPLAY CONTROL METHOD, AND FACILITY-INFORMATION DISPLAY SYSTEM

(71) Applicant: Mitsubishi Electric Corporation, Tokyo (JP)

(72) Inventors: Keito YOSHIMURA, Tokyo (JP); Mitsuo SHIMOTANI, Tokyo (JP)

(73) Assignee: Mitsubishi Electric Corporation, Tokyo (JP)

(21) Appl. No.: 15/309,715

(22) PCT Filed: Jun. 10, 2014
(86) PCT No.: PCT/JP2014/065326

§ 371 Date: Nov. 8, 2016

(51) Int. Cl. G01C 21/36; G01S 19/00; G01C 21/00

(52) U.S. Cl. CPC G01C 21/3682; G01C 21/005; G01S 19/00; G01C 21/3694; G01C 21/3644; G01C 21/3647

(57) ABSTRACT

Based on map information stored in a map-information storage, a display information generation/output unit generates display information for displaying, together with a map, facility information regarding service-providing facilities which provide a service using a function of predetermined public equipment, and outputs the generated display information to a display device. A controller controls the display-information generation/output unit to generate display information for displaying, in different modes on the map, the facility information of a service-providing facility among the service-providing facilities, the service-providing facility including recovery equipment enabling the service to be provided in place of the public equipment in a case where the public equipment does not function, and the facility information of a service-providing facility among the service-providing facilities, the service-providing facility not including the recovery equipment, and to output the generated display information to the display device.

### TECHNICAL FIELD

The present invention relates to a facility-information display control device, a facility-information display control method and a facility-information display system.

### BACKGROUND ART

A facility-information display control device allows a display device to display facility information regarding a facility that provides a variety of services, and assists a user in going to and using the facility. In a case where some failure occurs in the facility, and the facility cannot provide the services, then the facility-information display control device acquires facility information regarding another facility usable on around the facility where the failure occurs, allows the display device to display the acquired facility information, and thereby provides recovery information in unexpected circumstances.

Technologies regarding the facility-information display control device are disclosed, for example, in Patent Literatures 1 to 3.

### PRIOR ART DOCUMENTS

### Patent Documents

Patent Document 1: Japanese Patent Application Laid-Open No. 2012-53821

Patent Document 2: Japanese Patent Application Laid-Open No. 2011-196826

Patent Document 3: Japanese Patent Application Laid-Open No. 2012-220289

### SUMMARY OF THE INVENTION

### Problems to be Solved by the Invention

In the technologies disclosed in Patent Literatures 1 to 3, in a case where a regional failure, for example, an electric power failure occurs in public equipment such as electricity, water and gas, then there is sent information to the effect that the same type of facilities cannot be used in the whole of a region where the failure occurs in the public equipment.

Hence, even in a case where recovery equipment, which serves as an alternative of the public equipment, is provided individually and the usable facility is present in the region where the failure occurs in the public equipment, there is an apprehension that information to the effect that the facility concerned cannot be used may be sent.

It is an object of the present invention to provide a facility-information display control device, a facility-information display control method and a facility-information display system, which can display whether or not a facility including the recovery equipment, which serves as the alternative of the public equipment, is usable in a case where the public equipment does not function.

### Means for Solving the Problems

A facility-information display control device of the present invention includes: a map-information storage to store map information regarding a map; a display information generation/output unit that, based on the map information stored in the map-information storage, generates display information for displaying, together with the map, facility information regarding service-providing facilities which provide a service using a function of predetermined public equipment, and outputs the generated display information to a display device; and a controller that controls the display information generation/output unit to generate the display information for displaying, in different modes on the map, the facility information of a service-providing facility among the service-providing facilities, the service-providing facility including recovery equipment enabling the service to be provided in place of the public equipment in a case where the public equipment does not function, and the facility information of a service-providing facility among the service-providing facilities, the service-providing facility not including the recovery equipment, and to output the generated display information to the display device.

A facility-information display control method of the present invention is characterized in that, when map information regarding a map is acquired, and based on the acquired map information, display information for displaying, together with the map, facility information regarding service-providing facilities which provide a service using a function of predetermined public equipment is generated, and the generated display information is outputted to a display device, then there is generated the display information for displaying, in different modes on the map, the facility information of a service-providing facility among the service-providing facilities, the service-providing facility including recovery equipment enabling the service to be provided in place of the public equipment in a case where the public equipment does not function, and the facility information of a service-providing facility among the service-providing facilities, the service-providing facility not including the recovery equipment, and the generated display information is outputted to the display device.

A facility-information display system of the present invention is characterized by including: the facility-information display control device of the present invention, the facility-information display control device outputting, to the display device, display information for displaying, together with a map, facility information regarding service-providing facilities which provide a service using a function of predetermined public equipment; and a display device that performs map display of displaying an image including the map and the facility information based on the display information.

### Effects of the Invention

In accordance with the facility-information display control device of the present invention, by the display-information generation/output unit, based on the map information stored in the map-information storage, the display information for displaying, together with the map, the facility information regarding the service-providing facilities which provide the service using the function of the predetermined public equipment is generated, and the generated display information is outputted to the display device. The display-information generation/output unit is controlled by the controller to generate the display information for displaying the facility information of the service-providing facility among the service-providing facilities, which includes the recovery equipment enabling the service to be provided in place of the public equipment in the case where the public equipment does not function, and the facility information of the service-providing facility among the service-providing facilities, which does not include the recovery equipment, in different modes on the map, and to output the generated display information to the display device. In such a way, in the case where the public equipment does not function, whether or not the service-providing facility that includes the recovery equipment serving as the alternative of the public equipment is usable can be displayed on the display device.

In accordance with the facility-information display control method of the present invention, the map information regarding the map is acquired, and based on the acquired map information, the display information for displaying, together with the map, the facility information regarding the service-providing facilities which provide the service using the function of the predetermined public equipment is generated, and the generated display information is outputted to the display device. At this time, there is generated the display information for displaying the facility information of the service-providing facility among the service-providing facilities, which includes the recovery equipment enabling the service to be provided in place of the public equipment in the case where the public equipment does not function, and the facility information of the service-providing facility among the service-providing facilities, which does not include the recovery equipment, in different modes on the map, and the generated display information is outputted to the display device. In such a way, in the case where the public equipment does not function, whether or not the service-providing facility that includes the recovery equipment serving as the alternative of the public equipment is usable can be displayed on the display device.

In accordance with the facility-information display system of the present invention, by the facility-information display control device of the present invention, the display information for displaying, together with the map, the facility information regarding the service-providing facilities which provide the service using the function of the predetermined public equipment is outputted to the display device, and the display is performed based on the display information. In such a way, in the case where the public equipment does not function, whether or not the service-providing facility that includes the recovery equipment serving as the alternative of the public equipment is usable can be displayed on the display device.

Objects, features, aspects and advantages of the present invention will be more apparent by the following detailed description and the accompanying drawings.

### BRIEF DESCRIPTION OF DRAWINGS

FIG. 1 is a block diagram showing a configuration of a facility-information display system 1 as a first embodiment of the present invention.

FIG. 2 is a block diagram showing a configuration of a facility-information display system 2 as a second embodiment of the present invention.

FIG. 3 is a view showing an example of an image displayed on a display device 24 in a case where public equipment functions in the second embodiment of the present invention.

FIG. 4 is a view showing an example of an image displayed on the display device 24 in a case where the public equipment does not function in the prior art.

FIG. 5 is a view showing an example of an image displayed on the display device 24 in a case where the public equipment does not function in the second embodiment of the present invention.

FIG. 6 is a flowchart showing a procedure of route guidance processing by a facility-information display control device 10A.

FIG. 7 is a flowchart showing the procedure of the route guidance processing by the facility-information display control device 10A.

FIG. 8 is a diagram showing a display example of facility information of service-providing facilities.

FIG. 9 is a view showing another example of the image displayed on the display device 24 in the second embodiment of the present invention.

FIG. 10 is a view showing another example of the image displayed on the display device 24 in the second embodiment of the present invention.

FIG. 11 is a view showing still another example of the image displayed on the display device 24 in the case where the public equipment does not function.

FIG. 12 is a diagram showing an example of icons of charging stations.

### DESCRIPTION OF EMBODIMENTS

### First Embodiment

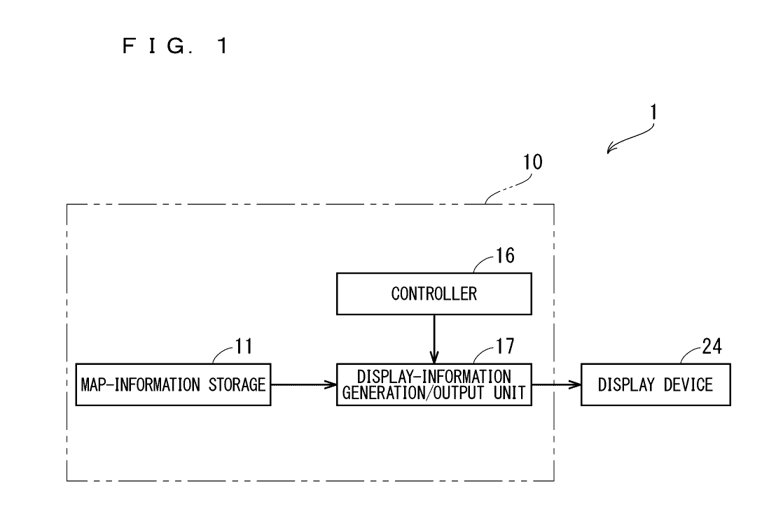

FIG. 1 is a block diagram showing a configuration of a facility-information display system 1 as a first embodiment of the present invention. The facility-information display system 1 is composed by including a facility-information display control device 10 and a display device 24. The facility-information display control device 10 includes a map-information storage 11, a controller 16 and a display-information generation/output unit 17.

The map-information storage 11 is realized by a storage device, for example, a hard disk drive (abbreviation: HDD) and a semiconductor memory. The map-information storage 11 stores map information regarding a map.

The map information is composed in such a manner that a plurality of maps corresponding to predetermined scales are layered on each other. The map information includes map display information for displaying the maps as images. The map display information includes road information regarding roads, facility information indicating types, names, positions and the like of facilities, various character information indicating place names, facility names, crossing names, road names and the like, and various icon information indicating the facilities, road numbers and the like. The facility information includes facility information regarding service-providing facilities.

For example, the controller 16 is composed of: a central processing unit (abbreviation: CPU); and a memory such as a writable RAM (Random Access Memory). The memory stores a control program. The CPU executes the control program stored in the memory, whereby respective functions of the map-information storage 11 and the display-information generation/output unit 17, which compose the facility-information display control device 10, are realized. The controller 16 controls the display-information generation/output unit 17.

In accordance with an instruction of the controller 16, the display-information generation/output unit 17 generates display information, which is to be displayed on the display device 24, based on the map information stored in the map-information storage 11, and specifically, by using the map information. The display-information generation/output unit 17 outputs the generated display information, and specifically, a video signal representing the display information to the display device 24.

The display information is information for displaying the facility information regarding the service-providing facilities together with the map. The service-providing facilities provide a service using a function of predetermined public equipment. For example, the public equipment is an electric power system, a water supply and a gas pipeline.

In a case where the public equipment is the electric power system, the service-providing facilities are charging stations, and as such a service as mentioned above, provides a charging service to charge batteries mounted on vehicles. In a case where the public equipment is the water supply, the service-providing facilities are water supply facilities, and provide a water supply service as such a service as mentioned above. In a case where the public equipment is the gas pipeline, the service-providing facilities are gas supply facilities, and provide a gas supply service as such a service as mentioned above.

In this embodiment, the controller 16 controls the display-information generation/output unit 17 to generate display information for displaying facility information of a service-providing facility among the service-providing facilities, which includes recovery equipment enabling the service to be provided in place of the public equipment in the case where the public equipment does not function, and facility information of a service-providing facility among the service-providing facilities, which does not include the recovery equipment, in different modes on the map, and to output the generated display information to the display device 24.

That is to say, through the display-information generation/output unit 17, the controller 16 controls the display device 24 to display the facility information of the service-providing facilities which include the recovery equipment and the facility information of the service-providing facilities which do not include the recovery equipment in different display modes on the map. Details of the display modes of the facility information will be described later.

For example, the display device 24 is realized by a liquid crystal display device. The display device 24 includes a display unit that displays an image. Based on the display information outputted from the display-information generation/output unit 17, the display device 24 performs map display of displaying a map image including the map and the facility information. Specifically, the display device 24 converts the display information, which is given from the display-information generation/output unit 17, into an image signal handleable in the display device 24, and displays an image, which corresponds to image information represented by the obtained image signal, on a display screen of the display unit.

For example, the display device 24 is a display device of a portable communication device such as a cellular phone, a smart phone and a tablet-type terminal device, or a display device of a car navigation apparatus mountable on a vehicle. The display device may be provided separately from a display device of the portable communication device, the car navigation apparatus or the like.

As described above, in accordance with this embodiment, based on the map information stored in the map-information storage 11, the display information for displaying, together with the map, the facility information regarding the service-providing facilities is generated by the display-information generation/output unit 17, and is outputted to the display device 24. The display-information generation/output unit 17 is controlled by the controller 16 to generate the display information for displaying the facility information of the service-providing facility among the service-providing facilities, which includes the recovery equipment, and the facility information of the service-providing facility among the service-providing facilities, which does not include the recovery equipment, in the different modes on the map, and to output the generated display information to the display device 24.

In such a way, in the display device 24, the facility information of the service-providing facilities which include the recovery equipment and the facility information of the service-providing facilities which do not include the recovery equipment are displayed in the different modes on the map. By this difference between the display modes, it can be indicated whether or not the service-providing facilities which include the recovery equipment are usable in the case where the public equipment does not function. As described above, in this embodiment, in the case where the public equipment does not function, whether or not the service-providing facility that includes the recovery equipment serving as the alternative of the public equipment is usable can be displayed on the display device 24.

### Second Embodiment

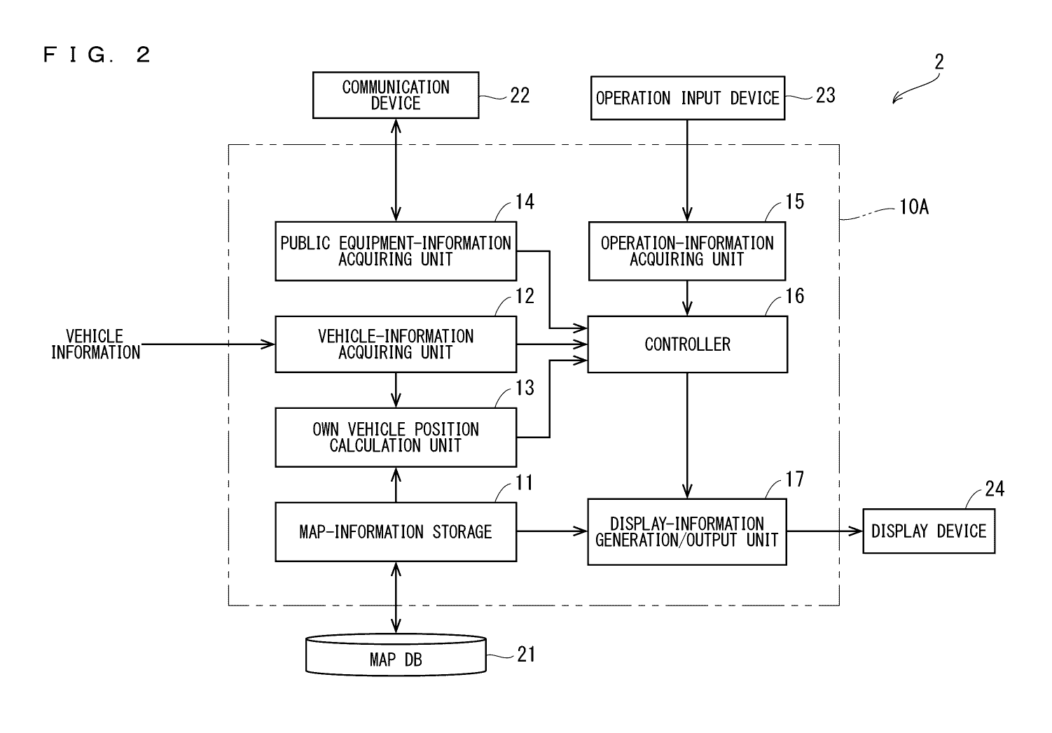

FIG. 2 is a block diagram showing a configuration of a facility-information display system 2 as a second embodiment of the present invention. The facility-information display system 2 is composed by including a facility-information display control device 10A, a map database (hereinafter, referred to as a “map DB” in some case) 21, a communication device 22, an operation input device 23 and a display device 24.

The facility-information display control device 10A includes a map-information storage 11, a vehicle-information acquiring unit 12, an own vehicle position calculation unit 13, a public equipment-information acquiring unit 14, an operation-information acquiring unit 15, a controller 16 and a display-information generation/output unit 17.

In the facility-information display control device 10A of this embodiment, the same constituents as those of the facility-information display control device 10 shown in FIG. 1 are given with the same reference numerals, and descriptions common thereto are omitted.

The map DB 21 is realized by a storage device such as a semiconductor memory, for example, an SD (Secure Digital) memory card or the like. The map DB 21 stores map information.

The map-information storage 11 reads out the map information from the map DB 21 in which the map information is stored, and stores the readout map information. In this embodiment, the facility-information display control device 10A is configured so that the map-information storage 11 can read out the map information from the map DB 21; however, is not limited to such a configuration.

The facility-information display control device 10A may be configured to acquire a whole or part of the map information from an outside, for example, by communication. Specifically, the facility-information display control device 10A may be configured to acquire the map information by downloading the map information from an external server device through a communication network such as the Internet. The acquired map information is stored in the map-information storage 11.

The vehicle-information acquiring unit 12 acquires a variety of vehicle information through an onboard network such as an in-vehicle LAN (Local Area Network). As the vehicle information, for example, there are a vehicle speed pulse signal that indicates a vehicle running speed (hereinafter, referred to as a “vehicle speed” in some case), a radio signal (hereinafter, referred to as a “GPS signal” in some case) from a global positioning system (abbreviation: GPS) satellite, gyro sensor information outputted from a gyro sensor, and battery charge information that indicates a charged capacity of a battery. The vehicle-information acquiring unit 12 gives the acquired vehicle information to the own vehicle position calculation unit 13 and the controller 16.

The own vehicle position calculation unit 13 reads out the map information stored in the map-information storage 11. By using the GPS signal given from the vehicle-information acquiring unit 12 and the map information read out from the map-information storage 11, the own vehicle position calculation unit 13 calculates a current position (hereinafter, referred to as an “own vehicle position” in some case) of the own vehicle. The own vehicle position calculation unit 13 gives position information, which indicates the calculated own vehicle position, to the controller 16.

The communication device 22 is configured to be communicable with an external communication device. The communication device 22 is realized, for example, by a cellular phone or a smart phone.

The public equipment-information acquiring unit 14 is communicably connected to the communication device 22. The public equipment-information acquiring unit 14 may be communicably connected to the communication device 22, for example, by radio such as Bluetooth (registered trademark) as a short-range wireless communication standard and a wireless LAN. Moreover, the public equipment-information acquiring unit 14 may be communicably connected to the communication device 22, for example, by wire such as a USB (Universal Serial Bus) cable and a LAN cable.

The public equipment-information acquiring unit 14 acquires public equipment information regarding the public equipment. Specifically, the public equipment-information acquiring unit 14 acquires public equipment information, which is transmitted from the external communication device, through the communication device 22. Moreover, the public equipment-information acquiring unit 14 is configured to be capable of making an inquiry about the public equipment information to the external server device through the communication device 22. As the public equipment information, for example, there are electric power failure information that indicates occurrence region and time range of an electric power failure, accident information that indicates an occurrence place of a traffic accident, a situation of the traffic accident, and the like, and disaster information that indicates an occurrence place of a disaster, a situation of the disaster, and the like. Moreover, the public equipment information includes facility information regarding service-providing facilities which provide a service using a function of the public equipment. The public equipment-information acquiring unit 14 gives the acquired public equipment information to the controller 16.

The operation input device 23 includes an operation input unit operated by a user. The operation input unit includes, for example, an operation switch and an operation button. The operation input device 23 is used when the user inputs information such as numeral information, character information and instruction information to the facility-information display control device 10A. When the operation input unit is operated by the user, the operation input device 23 generates operation information, which corresponds to an input operation of the user, and gives the generated operation information to the operation-information acquiring unit 15.

The operation input unit of the operation input device 23 may be composed of a touch panel or a voice input device capable of operation input by voice in place of the operation switch and the operation button. In a case where the operation input unit is composed of the touch panel, the touch panel is placed on a surface of the display device 24, and detects a touch operation and touch position of the user. The touch panel generates operation information, which responds to the detected touch operation and touch position, and gives the generated operation information to the controller 16. In a case where the operation input unit is composed of the voice input device, the voice input device recognizes an inputted voice. The voice input device generates operation information, which responds to the recognized voice, and gives the generation operation information to the controller 16.

The operation-information acquiring unit 15 acquires the operation information given from the operation input device 23. The operation information is information that indicates operation target and content, and for example, includes one or more pieces of information, which indicate a type of the operation, the number of times of the operation, a time length of the operation, an image to be operated and a display region of the image, display information volume, display position and display processing load of the image, an operation position or region on the screen of the display device 24, and the like.

The controller 16 is composed, for example, of a CPU and a memory such as a writable RAM. The memory stores a control program. The CPU executes the control program stored in the memory, whereby there are realized the respective functions of the map-information storage 11, the vehicle-information acquiring unit 12, the own vehicle position calculation unit 13, the public equipment-information acquiring unit 14, the operation-information acquiring unit 15 and the display-information generation/output unit 17, which compose the facility-information display control device 10A.

The controller 16 controls the display-information generation/output unit 17 based on the vehicle information given from the vehicle-information acquiring unit 12, the position information given from the own vehicle position calculation unit 13, and the public equipment information given from the public equipment-information acquiring unit 14. Specifically, the controller 16 controls the display-information generation/output unit 17 to generate display information for displaying facility information of the service-providing facility among the service-providing facilities, which includes recovery equipment enabling the service to be provided in place of the public equipment in the case where the public equipment does not function, and facility information of a service-providing facility among the service-providing facilities, which does not include the recovery equipment, in different modes on the map, and to output the generated display information to the display device 24.

The controller 16 has a function as a car navigation that guides a route from a current position to a destination. That is to say, by using the vehicle information given from the vehicle-information acquiring unit 12 and the position information given from the own vehicle position calculation unit 13, the controller 16 performs processing for allowing the map display to be performed, processing for allowing the own vehicle position to be displayed, route search processing, route conduction processing, route guidance processing and facility search processing.

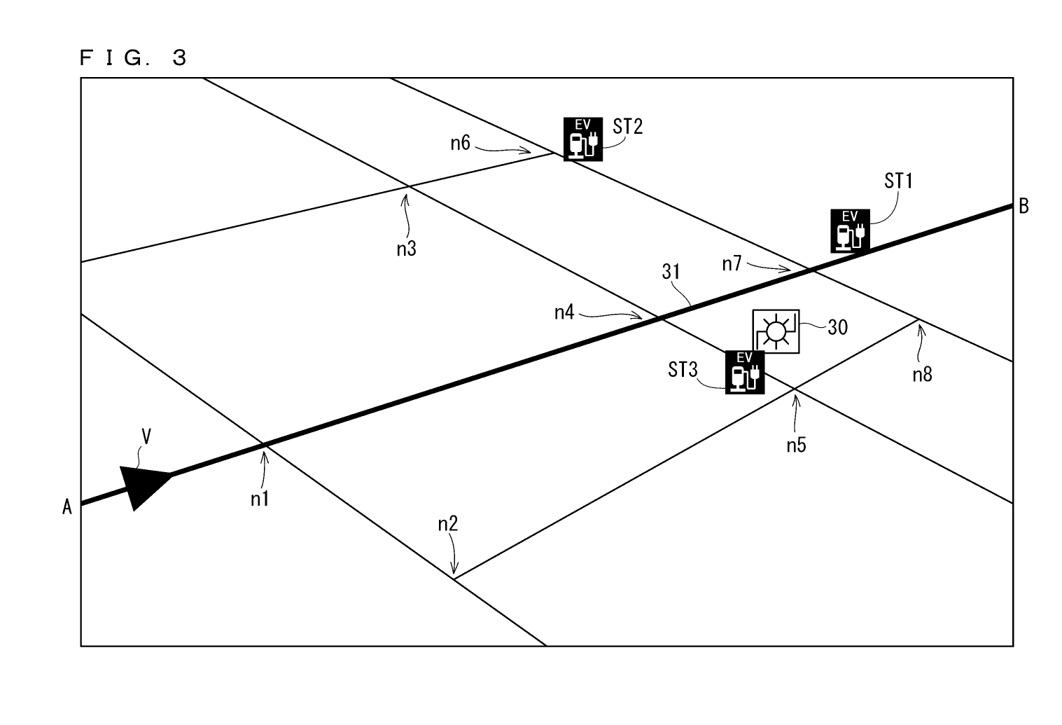

FIG. 3 is a view showing an example of an image displayed on the display device 24 in a case where the public equipment functions in the second embodiment of the present invention. In the example shown in FIG. 3, there is shown an image displayed on the display screen of the display unit of the display device 24 in a case where a motor-driven vehicle V is running from a point A in a direction toward a point B, and plans to be charged at a first charging station ST1. In FIG. 3, as nodes which represent crossings and points on roads, eight nodes which are a first node n1 to an eighth node n8 are shown. Moreover, in FIG. 3, as the charging stations, three charging stations which are first to third charging stations ST1 to ST3 are shown.

It is assumed that, as a running-scheduled route, a route is set, which goes from the point A via the first node n1, the fourth node n4, the seventh node n7 and the first charging station ST1 to the point B. In FIG. 3, the running-scheduled route is shown by a bold solid line, and reference numeral “31” is assigned thereto.

The first and second charging stations ST1 and ST2 are charging stations which do not include non-utility generation equipment as recovery equipment that enables a service to be provided in place of the public equipment. The third charging station ST3 is a charging station attached with the non-utility generation equipment as the recovery equipment. On upper right of an icon that represents the third charging station ST3, a mark (hereinafter, referred to as a “non-utility generation mark” in some case) 30 that indicates that the non-utility generation equipment is attached is given and displayed.

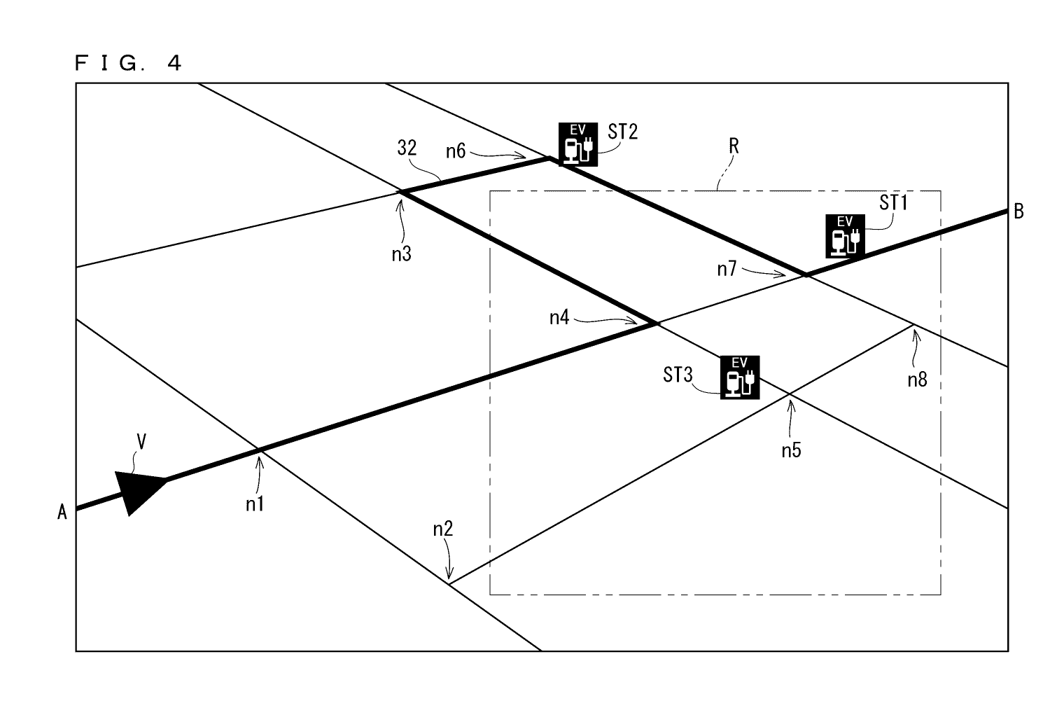

FIG. 4 is a view showing an example of an image displayed on the display device 24 in a case where the public equipment does not function in the prior art. In FIG. 4, there is shown a case where an electric power failure occurs in a region (hereinafter, referred to as an “electric power failure region” in some case) R surrounded by a chain double-dashed line, and an electric power system as the public equipment comes not to function therein.

In the prior art, in both of the case where the public equipment functions and the case where the public equipment does not function, as shown in FIG. 4, the above-mentioned non-utility generation mark 30 shown in FIG. 3 is not displayed on the display device 24. Hence, it is unknown whether or not the charging stations ST1 to ST3 are attached with the non-utility generation equipment.

In the prior art, in a case where the electric power failure occurs in the electric power failure region R, the non-utility generation mark 30 is not displayed on the display device 24 as mentioned above, and accordingly, the user cannot recognize that the third charging station ST3 is the charging station attached with the non-utility generator, and is capable of making a charge even at such a time of the electric power failure.

Also in the controller of the facility-information display control device, it cannot be recognized that the third charging station ST3 is the charging station attached with the non-utility generator, and is capable of making a charge even at the time of the electric power failure, and accordingly, the controller changes such a running plan of the motor-driven vehicle V so as to charge the motor-driven vehicle V at the second charging station ST2.

In such a way, the running-scheduled route is changed to a route 32 that goes from the point A via the first node n1, the fourth node n4, the third node n3, the sixth node n6 and the second charging station ST2 and the seventh node n7 to the point B. In FIG. 4, the running-scheduled route is shown by a bold solid line, and reference numeral “32” is assigned thereto.

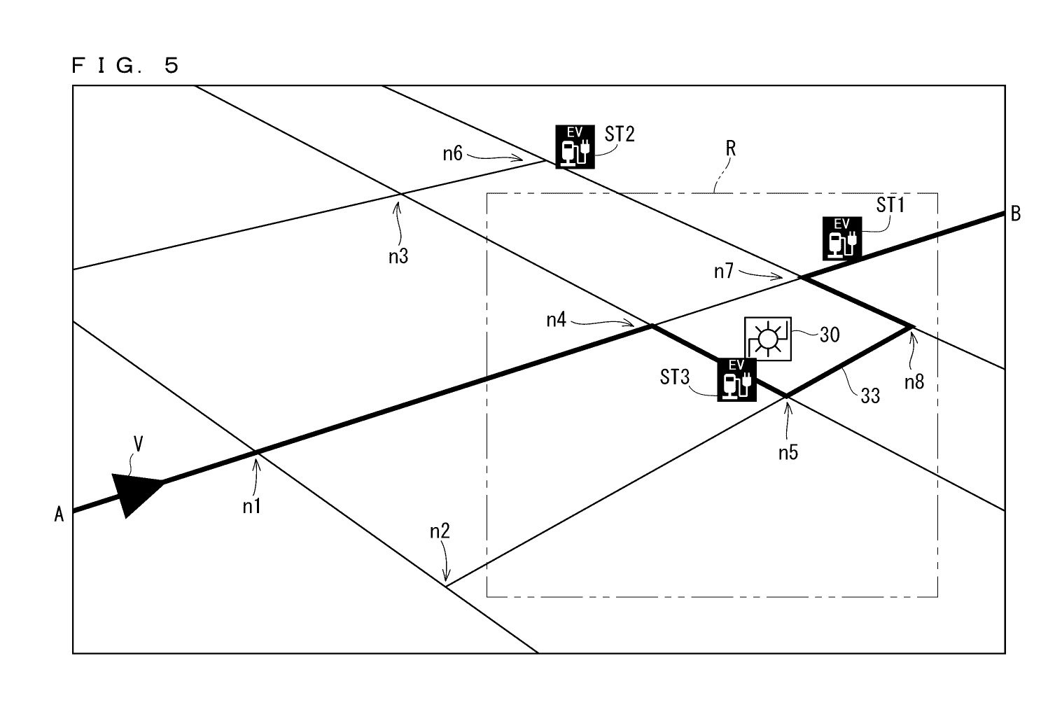

FIG. 5 is a view showing an example of an image displayed on the display device 24 in a case where the public equipment does not function in the second embodiment of the present invention. In this embodiment, in the case where the public equipment does not function, in a similar way to the case shown in FIG. 3, where the public equipment functions, the non-utility generation mark 30 is displayed on the upper right of the icon, which represents the third charging station ST3, as shown in FIG. 5. In such a way, the user can recognize that the third charging station ST3 is the charging station attached with the non-utility generation equipment, and is capable of making the charge even at the time of the electric power failure.

Moreover, the controller 16 of the facility-information display control device 10A can also recognize that the third charging station ST3 is the charging station attached with the non-utility generation equipment, and is capable of making the charge even at the time of the electric power failure. Hence, the controller 16 changes the running plan of the motor-driven vehicle V so that the motor-driven vehicle V can be charged by the third charging station ST3.

In such a way, the running-scheduled route is changed to a route 33 that goes from the point A via the first node n1, the fourth node n4, the third charging station ST3, the fifth node n5, the eighth node n8 and the seventh node n7 to the point B. In FIG. 5, the running-scheduled route is shown by a bold solid line, and reference numeral “33” is assigned thereto.

A route length of the running-scheduled route 33 shown in FIG. 5 is shorter in comparison with a route length of the running-scheduled route 32 shown in FIG. 4. As described above, in accordance with this embodiment, the route length of the running-scheduled route can be shortened, and accordingly, an energy consumption of the motor-driven vehicle V can be reduced.

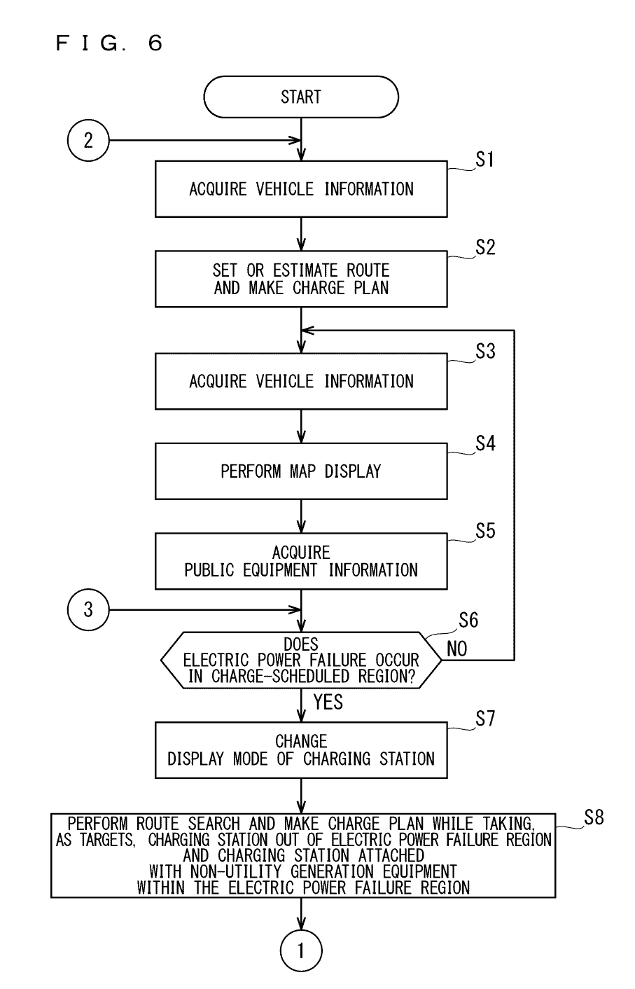

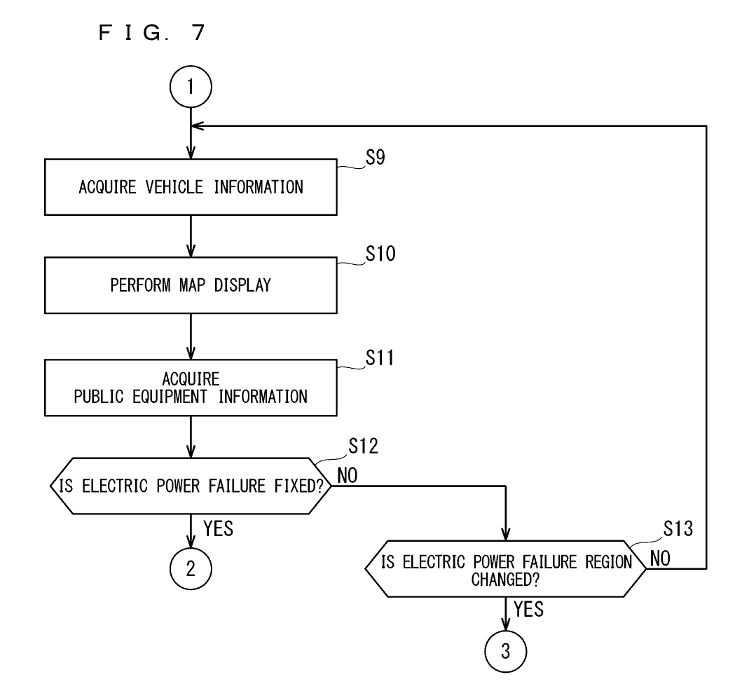

FIG. 6 and FIG. 7 are flowcharts showing a procedure of the route guidance processing by the facility-information display control device 10A. The facility-information display control device 10A has a function of the car navigation, and for example, performs the route guidance processing.

Respective pieces of the processing shown in the flowcharts shown in FIG. 6 and FIG. 7 are executed by the map-information storage 11, the vehicle-information acquiring unit 12, the own vehicle position calculation unit 13, the public equipment-information acquiring unit 14, the operation-information acquiring unit 15, the controller 16 and the display-information generation/output unit 17 of the facility-information display control device 10A. When the destination is inputted by the user by using the operation input device 23, and operation information that indicates the inputted destination is acquired by the operation-information acquiring unit 15, then the processing of the flowcharts shown in FIG. 6 and FIG. 7 is started, and proceeds to Step S1.

In Step S1, the vehicle-information acquiring unit 12 acquires the vehicle information through the network such as the in-vehicle LAN.

In Step S2, the controller 16 sets or estimates the route and makes a charge plan.

In Step S3, the vehicle-information acquiring unit 12 acquires the vehicle information in a similar way to Step S1.

In Step S4, the display-information generation/output unit 17 performs the map display by outputting the display information to the display device 24. The display device 24 performs the map display based on the display information given from the display-information generation/output unit 17.

In Step S5, the public equipment-information acquiring unit 14 acquires the public equipment information through the communication device 22.

In Step S6, the controller 16 determines whether or not the electric power failure occurs in a charge-scheduled region based on the public equipment information acquired in Step S5. In a case where it is determined that the electric power failure occurs in the charge-scheduled region, then the processing proceeds to Step S7, and in a case where it is determined that the electric power failure does not occur in the charge-scheduled region, then the processing returns to Step S3.

In Step S7, the display-information generation/output unit 17 changes the display mode of the charging stations. Specifically, the display-information generation/output unit 17 makes setting so that the charging station out of an electric power failure region and the charging station attached with the non-utility generation equipment within the electric power failure region can be displayed in the different modes on the map.

In Step S8, while taking, as targets, the charging station out of the electric power failure region and the charging station attached with the non-utility generation equipment within the electric power failure region, the controller 16 performs the route search and makes the charge plan. After the processing of Step S8 is ended, the processing proceeds to Step S9 of FIG. 7.

In Step S9 in FIG. 7, the vehicle-information acquiring unit 12 acquires the vehicle information in a similar way to Step S1 and Step S3 in FIG. 6.

In Step S10, based on the map information stored in the map-information storage 11, on results of the route search and the charge plan, which are performed and made in Step S8, and on the vehicle information acquired in Step S9, the display-information generation/output unit 17 generates the display information so as to form the display mode changed in Step S7, and outputs the generated display information to the display device 24, and thereby performs the map display. The display device 24 performs the map display based on the display information given from the display-information generation/output unit 17.

In Step S11, the public equipment-information acquiring unit 14 acquires the public equipment information in a similar way to Step S5 in FIG. 6.

In Step S12, the controller 16 determines whether or not the electric power failure is fixed based on the public equipment information acquired in Step S11. In a case where it is determined that the electric power failure is fixed, then the processing returns to Step S1 of FIG. 6, and in a case where it is determined that the electric power failure is not fixed, then the processing proceeds to Step S13.

In Step S13, the controller 16 determines whether or not the electric power failure region is changed based on the public equipment information acquired in Step S11. In a case where it is determined that the electric power failure region is changed, then the processing proceeds to Step S6 in FIG. 6, and in a case where it is determined that the electric power failure region is not changed, then the processing returns to Step S9.

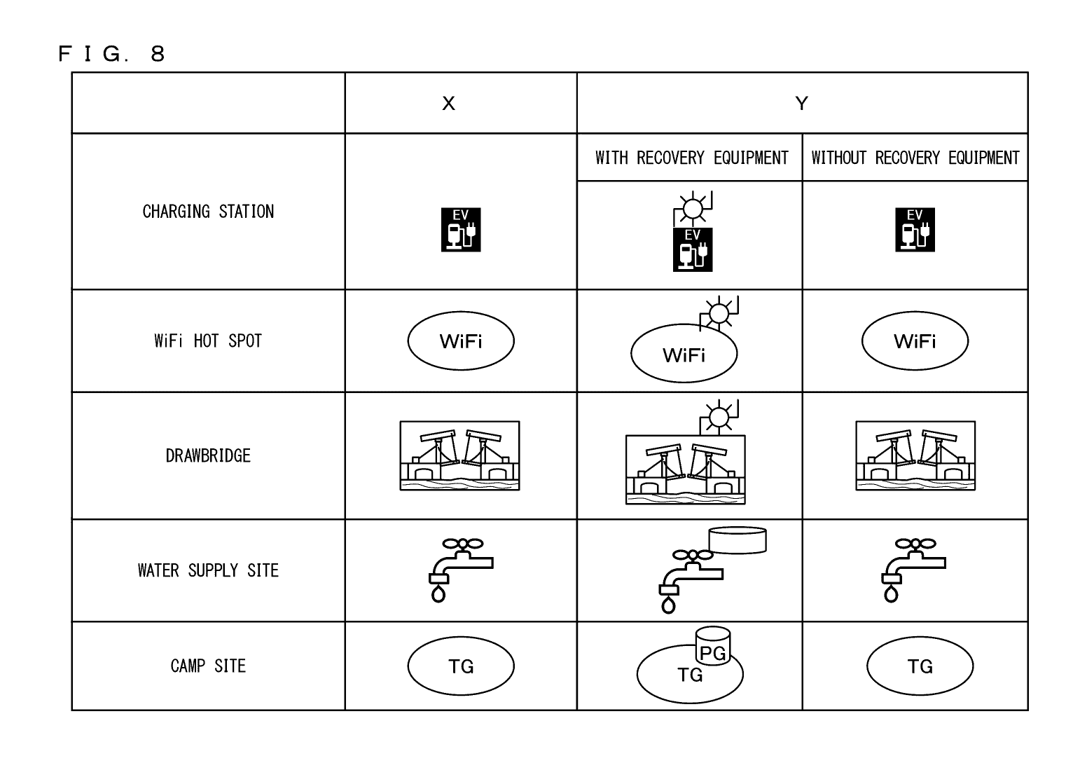

FIG. 8 is a diagram showing a display example of the facility information of the service-providing facilities. FIG. 8 shows display examples of icons which represent the service-providing facilities with regard to the charging stations, WiFi (registered trademark) hot spots, drawbridges, water supply sites and camp sites, which are the service-providing facilities. In FIG. 8, display examples in the prior art are shown in columns of “X”, and display examples in this embodiment are shown in columns of “Y”.

As shown in FIG. 8, in the prior art, the service-providing facilities are shown by the same icon no matter whether or not the recovery equipment may be present. In contrast, in this embodiment, on the upper right of each of the icons of the service-providing facilities attached with the recovery equipment, a mark (hereinafter, referred to as a “recovery mark” in some case) representing that the recovery equipment is attached is added and displayed. The recovery mark is not added or displayed onto the icon of each of the service-providing facilities without the recovery equipment.

In a case of a service-providing facility that provides a service by the electric power system, for example, the charging station, the WiFi (registered trademark) hot spot, and the drawbridge, the recovery mark has a pattern, for example, similar to the map symbol of a generating station.

In a case of a service-providing facility that provides a service by the water supply, for example, the water supply site, the recovery mark has a pattern, for example, schematically showing a water storage tank. In a case of a service-providing facility that provides a service by a gas pipeline, such as town gas (abbreviation: TG), for example, the camp site, the recovery mark has a pattern, for example, schematically showing propane gas (abbreviation: PG) cylinder.

As described above, in accordance with this embodiment, in a similar way to the first embodiment, the display-information generation/output unit 17 is controlled by the controller 16 to generate the display information for displaying the facility information of the service-providing facility among the service-providing facilities, which includes the recovery equipment, and the facility information of the service-providing facility among the service-providing facilities, which does not include the recovery equipment, in the different modes on the map, and to output the generated display information to the display device 24. Hence, in the case where the public equipment does not function, whether or not the service-providing facility that includes the recovery equipment serving as the alternative of the public equipment is usable can be displayed on the display device 24.

For example, in a case where the public equipment is the electric power system, the recovery equipment is the non-utility generation equipment, and the service-providing facilities are the charging stations which provide the charging service of charging the battery mounted on the motor-driven vehicle, then the facility information is displayed in the different modes as mentioned above, whereby the user can easily recognize the usable charging station.

Moreover, as shown in FIG. 8, in a case where the public equipment is the water supply, the recovery equipment is the water storage tank, and the service-providing facilities are the water supply facilities which provide the water supply service, then the facility information is displayed in the different modes as mentioned above, whereby the user can easily recognize the usable water supply facility.

Moreover, as shown in FIG. 8, in a case where the public equipment is the gas pipeline, the recovery equipment is a gas cylinder, and the service-providing facilities are the gas supply facilities which provide the gas supply service, then the facility information is displayed in the different modes as mentioned above, whereby the user can easily recognize the usable gas supply facility.

In this embodiment, as shown in FIG. 6 and FIG. 7, which are mentioned above, the controller 16 performs at least one of the route search and the generation of the running plan of the vehicle based on the facility information of the service-providing facility that includes the recovery equipment and on the facility information of the service-providing facility that does not include the recovery equipment. In such a way, a running distance can be prevented from becoming undesirably longer, and accordingly, the energy consumption of the motor-driven vehicle V can be reduced.

Moreover, in this embodiment, as shown in FIG. 6 and FIG. 7, which are mentioned above, the controller 16 performs at least one of the route search and the generation of the running plan of the vehicle one more time in the case where the public equipment does not function. In such a way, the running distance can be prevented more surely from becoming undesirably longer, and accordingly, the energy consumption of the motor-driven vehicle V can be reduced more surely.

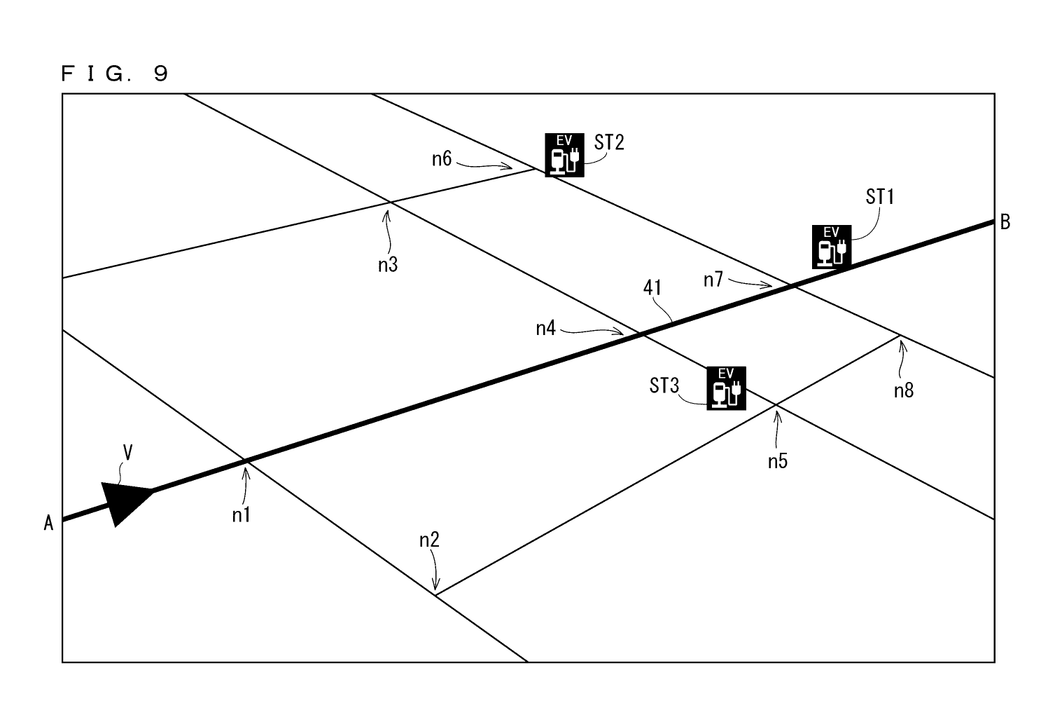

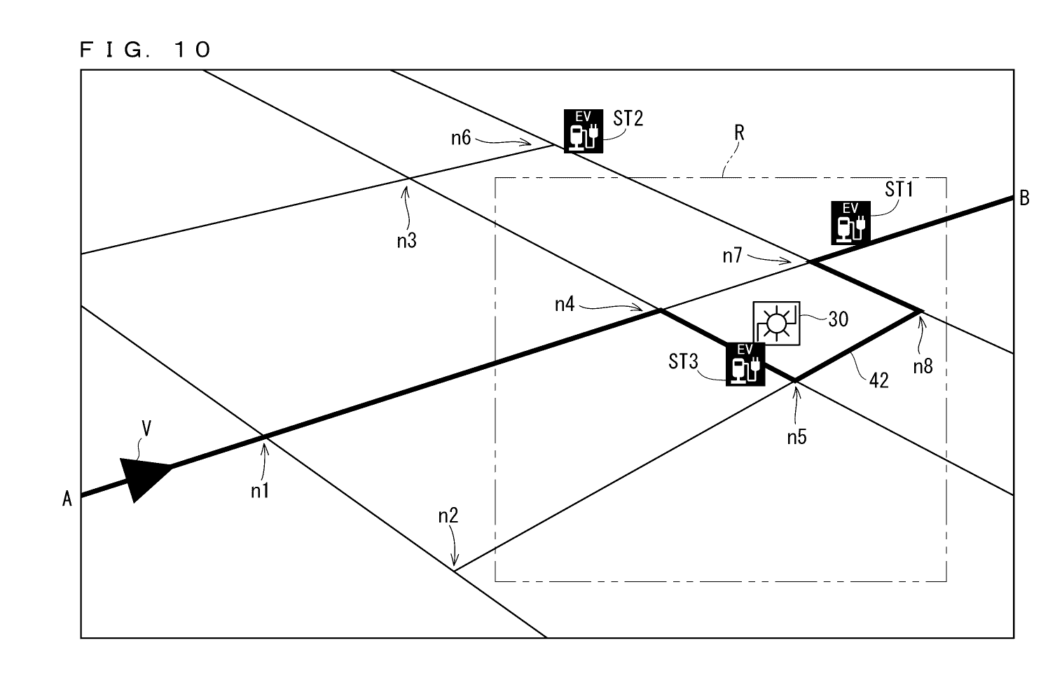

FIG. 9 and FIG. 10 are views showing another example of the image displayed on the display device 24 in the second embodiment of the present invention. In the example shown in FIG. 9 and FIG. 10, the public equipment is the electric power system in a similar way to FIG. 3 to FIG. 5, which are mentioned above. In a case where the electric power system as the public equipment functions, then as shown in FIG. 9, all of the first to third charging stations ST1 to ST3 are displayed by the same icon.

In a case where the electric power system does not function, for example, in a case where the electric power failure occurs in the electric power failure region R surrounded by a chain double-dashed line as shown in FIG. 10, the icon of the third charging station ST3 is changed to the icon added with the recovery mark 30. As described above, in the case where the electric power failure occurs, then the third charging station ST3 is displayed in such a display mode in which it is easily understood that the third charging station ST3 is the charging station attached with the non-utility generation equipment.

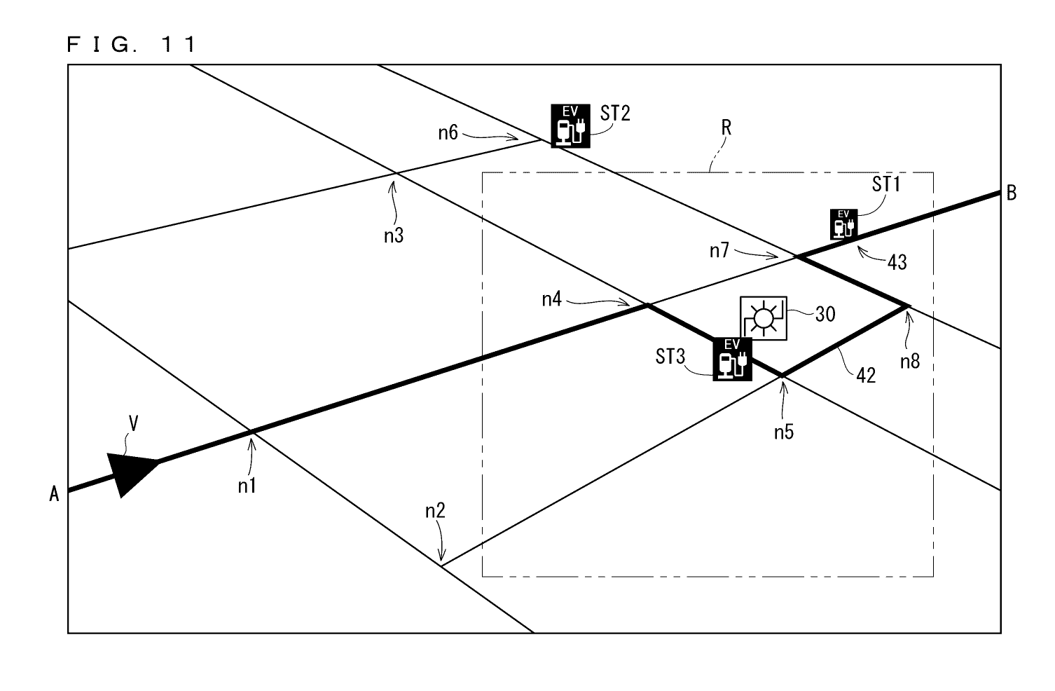

FIG. 11 is a view showing still another example of the image displayed on the display device 24 in the case where the public equipment does not function. FIG. 11 shows a display mode in the case where the electric power system does not function. In the case where the electric power system functions, then as shown in FIG. 9 mentioned above, all of the first to third charging stations ST1 to ST3 are displayed by the same icon.

As shown in FIG. 11, in the case where the electric power failure occurs in the electric power failure region R surrounded by a chain double-dashed line, an icon of the charging station unusable in the electric power failure region R, that is, of the charging station without the non-utility generation equipment is displayed to be smaller than an icon of the charging station usable therein, that is, of the charging station attached with the non-utility generation equipment. In the example shown in FIG. 11, as shown by reference numeral “43”, the icon of the first charging station ST1 is displayed to be smaller than the icon of the third charging station ST3.

This change of the display is performed in such a manner that the controller 16 controls the display-information generation/output unit 17. Specifically, based on the public equipment information acquired by the public equipment-information acquiring unit 14, the controller 16 controls the display-information generation/output unit 17 to change the display mode of the facility information between the case where the public equipment does not function and the case where the public equipment functions. In such a way, the user can easily recognize the usable service-providing facility.

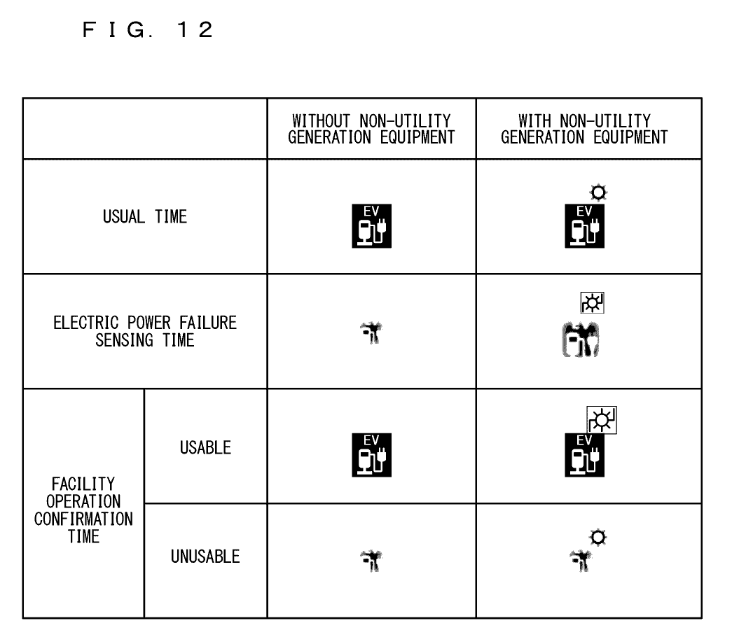

FIG. 12 is a diagram showing an example of the icons of the charging stations. In the example shown in FIG. 11, the icon of the charging station unusable in the electric power failure region R is displayed to be smaller than the icon of the charging station usable therein; however, as shown in FIG. 12, the display mode may be changed depending on whether or not the charging station is attached with the non-utility generation equipment.

For example, in usual, that is to say, in the case where the electric power system as the public equipment functions, then in a similar way to FIG. 3 mentioned above, the charging station without the non-utility generation equipment is displayed by only the icon that represents the charging station. The charging station attached with the non-utility generation equipment is displayed while adding the non-utility generation mark, which indicates that the charging station is attached with the non-utility generation equipment, to the icon that represents the charging station. The non-utility generation mark is added, for example, to the upper right of the icon. A position to which the non-utility generation mark is added is not limited to this, and may be other positions.

When the electric power failure is sensed, a condition of the charging station, for example, whether the charging station is usable or unusable is expressed by blurring, translucency, tone, and size. For example, the icon of the charging station, which does not include the non-utility generation equipment and is unusable at the time of the electric power failure, is displayed to be blurred with a size smaller than usual as shown in a column of “No Non-Utility Generation Equipment” at “When Electric Power Failure is Sensed” in FIG. 12.

The icon of the charging station, which includes the non-utility generation equipment and may be usable, is displayed to be blurred with the same size as usual, and is displayed while adding the non-utility generation mark to the upper right thereof, for example, as shown in a column of “With Non-Utility Generation Equipment” at “When Electric Power Failure is Sensed” in FIG. 12.

The controller 16 may confirm the condition of the service-providing facility, that is, whether or not the service-providing facility is operating in the case where the public equipment does not function, and may control the display-information generation/output unit 17 to change the display mode of the icon that is the facility information as shown in FIG. 12 between before and after making this confirmation. In such a way, the user can easily recognize the usable service-providing facility.

For example, in the case where the public equipment is the electric power system as shown in FIG. 12, when the electric power failure is sensed, the controller 16 confirms whether or not the charging station as the service-providing facility is operating, that is, whether or not the service-providing facility is usable. Based on a result of the confirmation, the controller 16 controls the display-information generation/output unit 17 to change the display mode of the icon between before the confirmation, that is, a time when the electric power failure is sensed and after the confirmation, that is, a facility operation confirmation time as a point of time when it is confirmed that the facility is operating.

In the example shown in FIG. 12, as shown in a column of “Facility Operation Confirmation Time”, the charging station without the non-utility generation equipment is displayed by the same icon as usual in the case of being usable. Moreover, the charging station without the non-utility generation equipment is displayed by the same icon as when the electric power failure is sensed, for example, by a blurred icon in the case of being unusable.

In the case of being usable, the charging station attached with the non-utility generation equipment is displayed while adding a clear non-utility generation mark with a size larger than usual to the same icon as usual. Moreover, in the case of being usual, the charging station attached with the non-utility generation equipment is displayed while adding the non-utility generation mark to a blurred icon with a size smaller than when the electric power failure is sensed. At this time, the non-utility generation mark is also displayed while being blurred. The icon of the charging station attached with the non-utility generation equipment in the case of being unusable at the facility operation confirmation time is the same as the icon of the charging station without the non-utility generation equipment at such an electric power failure sensing time and as the icon without the non-utility generation equipment in the case of being unusable at the facility operation confirmation time.

As described above, the controller 16 may be configured to control the display-information generation/output unit 17 to change the display mode of the icon as the facility information in an order of the usual time, the electric power failure sensing time and the facility operation confirmation time. In such a way, the user can recognize the condition of the service-providing facility more accurately.

The facility-information display control device of each of the embodiments described above can also be applied to a facility-information display control device constructed as a system by appropriately combining a car navigation device, a communication terminal device, a server device and the like, which are mountable on the vehicle, with one another. The communication terminal device is, for example, a PND (Portable Navigation Device) and a portable communication device, each of which has a function to communicate with the server device. The portable communication device is, for example, a cellular phone, a smart phone and a tablet-type terminal device.

As mentioned above, in the case where the system is constructed by appropriately combining the facility-information display control device, the communication terminal device and the server device with one another, the respective functions and respective constituent elements of the facility-information display control device of each of the above-mentioned embodiments are dispersively arranged in the respective devices which construct the above-described system.

Note that, in the present invention, it is possible to freely combine the respective embodiments with each other within the scope of the invention. Moreover, it is possible to appropriately change or omit arbitrary constituent elements of the respective embodiments.

Although the present invention has been described in detail, the above description is illustration in all aspects, and the present invention is not limited to this. It is interpreted that innumerable modification examples, which are not illustrated, are conceivable without departing from the scope of the present invention.

### REFERENCE SIGNS LIST

1,2: Facility-information display system
10,10A: Facility-information display control device
11: Map-information storage
12: Vehicle-information acquiring unit
13: Own vehicle position calculation unit
14: Public equipment-information acquiring unit
15: Operation-information acquiring unit
16: Controller
17: Display-information generation/output unit
21: Map DB
22: Communication device
23: Operation input device
24: Display device

1. A facility-information display control device comprising:
a map-information storage to store map information regarding a map;
a processor to execute a program; and
a memory to store the program which, when executed by the processor, results in performance of steps comprising,
based on said map information stored in said map-information storage, generating display information for displaying, together with said map, facility information regarding service-providing facilities which provide a service using a function of predetermined public equipment,
outputting said generated display information to a display device; and
controlling to generate said display information for displaying, in different modes on said map, said facility information of a service-providing facility among said service-providing facilities, said service-providing facility including recovery equipment enabling said service to be provided in place of said public equipment in a case where said public equipment does not function, and said facility information of a service-providing facility among said service-providing facilities, said service-providing facility not including said recovery equipment, and to output said generated display information to said display device.

2. The facility-information display control device according to claim 1,
wherein said steps further comprise
acquiring public equipment information that indicates a condition of said public equipment, and
controlling includes changing a display mode of said facility information between the case where said public equipment does not function and a case where said public equipment functions based on acquired said public equipment information.

3. The facility-information display control device according to claim 1,
wherein said controlling includes:
confirming a condition of said service-providing facility in the case where said public equipment does not function, and
controlling to change a display mode of said facility information between before the confirmation and after the confirmation.

4. The facility-information display control device according to claim 1,
wherein said public equipment is an electric power system,
said recovery equipment is a non-utility generation equipment, and
said service-providing facilities are charging stations which provide, as said service, a charging service of charging a battery mounted on a vehicle.

5. The facility-information display control device according to claim 1,
wherein said public equipment is water supply,
said recovery equipment is a water storage tank, and
said service-providing facilities are water supply facilities which provide a water supply service as said service.

6. The facility-information display control device according to claim 1,
wherein said public equipment is a gas pipeline,
said recovery equipment is a gas cylinder, and
said service-providing facilities are gas supply facilities which provide a gas supply service as said service.

7. The facility-information display control device according to claim 1,
wherein said controlling includes:
performing at least one of route search and generation of a running plan of a vehicle based on said facility information of the service-providing facility that includes said recovery equipment and on said facility information of the service-providing facility that does not include said recovery equipment.

8. The facility-information display control device according to claim 7,
wherein said controlling includes:
performing at least one of said route search and said generation of the running plan of the vehicle one more time in the case where said public equipment does not function.

9. A facility-information display control method wherein:
when map information regarding a map is acquired; and
based on said acquired map information, display information for displaying, together with said map, facility information regarding service-providing facilities which provide a service using a function of predetermined public equipment is generated, and said generated display information is outputted to a display device;
then there is generated said display information for displaying, in different modes on said map, said facility information of a service-providing facility among said service-providing facilities, said service-providing facility including recovery equipment enabling said service to be provided in place of said public equipment in a case where said public equipment does not function, and said facility information of a service-providing facility among said service-providing facilities, said service-providing facility not including said recovery equipment, and said generated display information is outputted to said display device.

10. A facility-information display system comprising:
the facility-information display control device according to claim 1, the facility-information display control device outputting, to said display device, display information for displaying, together with a map, facility information regarding service-providing facilities which provide a service using a function of predetermined public equipment; and
a display device that performs map display of displaying an image including said map and said facility information based on said display information.
